(19) United States
(12) Patent Application Publication
(10) Pub. No.: US 2013/0218736 A1
(43) Pub. Date: Aug. 22, 2013

(54) CROSSED MARKET ALERT METHOD FOR OVER-THE-COUNTER (OTC) MARKETS

(71) Applicants: Andrew H. Eisen, Stamford, CT (US); Malcolm J. McDonald, Brooklyn, NY (US); Jonathan A. Newell, Mount Kisco, NY (US)

(72) Inventors: Andrew H. Eisen, Stamford, CT (US); Malcolm J. McDonald, Brooklyn, NY (US); Jonathan A. Newell, Mount Kisco, NY (US)

(73) Assignee: MARKIT NORTH AMERICA, INC., New York, NY (US)

(21) Appl. No.: 13/401,949

(22) Filed: Feb. 22, 2012

(51) Int. Cl. G06Q 40/00

(52) U.S. Cl. 705/35

(57) ABSTRACT

A method for use in over-the-counter (OTC) financial markets to selectively generate and transmit crossing market alerts to market participants (e.g., market makers or liquidity providers). The method includes providing an alert generation system with a processor executing code to provide a crossing markets module. The method also includes, with the crossing markets module, receiving from a data source a set of market data defining pricing for a financial instrument, such as a bond, credit default swap (CDS) or other swap, or loan. Then, the method includes receiving a quote for the financial instrument from a market maker. The method involves comparing pricing data in the quote with the pricing for the financial instrument defined by the market data to identify a crossing markets event. The method includes generating a crossing markets alert when a set of alert generation rules, including surpassing an economic threshold, are met.

### BACKGROUND

1. Field of Description

The present disclosure relates, in general, to computer-implemented methods for analyzing and processing pricing information in over-the-counter (OTC) markets such as the illiquid markets for financial instruments such as bonds, loans, etc., and, more particularly, to improved methods and systems for identifying crossed markets in an OTC market (in contrast to a published market as found in a typical exchange or transparent market) and for selectively generating alerts to the market makers or liquidity providers in the OTC market, e.g., to a buyer or seller in an OTC market for bonds or loans.

2. Relevant Background

Many financial instruments such as stocks are traded through exchanges. Exchanges facilitate liquidity by standardizing products traded on the exchange for transparent trading. During a trading day, the buyers and sellers have access to published real-time prices or to the present “price in time” for each exchange-traded instrument or product.

In contrast, over-the-counter (OTC) markets (or OTC derivatives markets) are used to trade financial instruments directly between two parties, and OTC markets do not publish the exchange price. The financial instruments vary in OTC markets but typically include bonds, loans, credit default swaps (CDSs), variance swaps, credit options, and similar types of instruments. An OTC contract is a bilateral contract in which two parties agree on how a particular trade is to be settled in the future. Market makers are needed to allow OTC markets to function by providing liquidity by standing ready to take either side of a trade (to offer to buy or sell) and, in doing so, earning the spread between the buy and sell price for such a service.

During operation of an OTC market, liquidity providers distribute price quotes that provide an indicative bid and ask price for one or more financial instruments. These quotes are not published to the entire market but only to a select list of the market makers' clients. When publishing these quotes, the market maker does not have clear indication of what the current best prices are for each instrument. As a result, the market maker runs the risk that the prices they quote are executed upon by clients even when the market maker's prices are off market (e.g., too high a bid price or too low of an ask price). The liquidity provider's task can be considered a delicate balancing act since the price quotes they provide need to be determined such that they balance the buyers and sellers so the liquidity provider avoids taking on unnecessary risks.

OTC markets lack the transparency of exchange-traded markets that function in real time and disclose prices and trading activity in real time or with minimal delay. As a result, liquidity providers or market makers face increased risk because it can be difficult to provide price quotes that are not crossed with other liquidity providers' quotes on an instrument. In certain markets, this circumstance is also referred to as “backwardation.” Crossed markets result, first, when the market maker's offering or asking price is lower than any other market maker's bid price for the same instrument, and second, when the market maker's bid price is higher than any other market maker's asking price. In the first crossed market circumstance, the liquidity provider is obligated to sell at a potential loss over the true market price, and, in the second circumstance, the liquidity provider is obligated to buy at an unknown premium to market.

In recent years, in part due to the financial crisis of 2008 and present market turmoil, a combination of a lack of liquidity and historically high volatility has been problematic for the OTC markets (e.g., fixed income and credit markets). These conditions have resulted in an increase in market makers crossing prices and have driven demand by market makers for solutions that can limit their risks associated with crossed market quotes. For example, liquidity providers are requesting additional intraday data to help them ensure that they are correctly pricing instruments when making markets. Presently, no adequate solution exists for market makers to address the risks of offering crossed prices in OTC markets.

OTC books of record pricing data are traditionally made available at the end of each business day by data providers. For the OTC markets to function, market makers source intraday indicative and trade price levels from multiple interdealer brokers, but these prices can differ at any single point in time, are subject to change, and are valid for only a short time. Thus, market makers are forced to consolidate this often stale pricing data from multiple data sources, often in different or multiple formats. The market makers attempt, often unsuccessfully, to prevent crossing markets with other liquidity providers through the use of spreadsheets, data services, and other make-shift, internal tools to determine what a good bid and ask price is for a financial instrument.

The existing pricing process has a number of problems. First, the price discovery or setting process can take a significant amount of time. Second, the process is often inefficient as prices continuously change, forcing it to be repeated frequently. Third, after the price is set, a risk remains that the bid price or the ask price in a quote for an instrument is too high or too low (i.e., the market price is still ambiguous or unknown to the market maker) since the market maker who quoted the price is not privy to other market maker quotes. Fourth, the process is open to user error.

Hence, the market needs a tool to reduce the risk associated with crossed prices in the OTC markets and other non-exchange markets for financial instruments. This tool, which can be a software product, preferably, would help compensate for the above-discussed problems including the problems that instrument prices fluctuate during a trading period (e.g., on an intraday basis) and that presently market makers or liquidity providers are unaware of other trading counterparties' indicative pricing levels until the end of a trading period, e.g., when end-of-day composite pricing is published. Particularly, it would be useful for the tool to provide more timely information or feedback as to whether a market maker's quotes for an instrument are reasonable, or minimally, when a price is crossed for an instrument or security.

### SUMMARY

Briefly, the problems associated with crossed markets in a non-exchange-based market such as an over-the-counter (OTC) market can be addressed by providing an alert generation system. This system uses a quotes analysis module or tool first to process market makers' quotes (e.g., bids and asks) for a particular financial instrument (e.g., a bond, a loan, a credit default swap (CDS), etc.) and compare those quotes with other market pricing data to determine if and when the price quotes for the instrument have been crossed. Once a crossed price event is identified, the quotes analysis module acts to determine whether an alert should be generated by applying a set of alert generation rules. For example, an economic threshold can be defined for each instrument or for an asset class of instruments and an alert generated only when the quoted price deviates from observed prices for that instrument provided by other market participants by the economic threshold (e.g., the difference is economically interesting for the market maker).

More particularly, a computer-implemented method is provided for use in over-the-counter (OTC) financial markets to selectively generate and transmit crossed market alerts to market participants (e.g., market makers or liquidity providers). The method includes providing an alert generation system on a digital communications network where the server, including a processor, executes code to provide a quotes analysis module (e.g., a software product or tool used to determine when crossed markets are occurring for a market and when to respond by generating an alert). The method also includes, with the quotes analysis module, monitoring multiple price data sources (e.g., sets of market data defining pricing for financial instruments such as bonds, loans, options, swaps (e.g., credit default swaps (CDSs), variance swaps, or volatility swaps), swaptions, tranches, index rolls, or other OTC-traded products). Then, the method includes receiving a quote for the financial instrument from a market maker. Next, the method involves, with the quotes analysis module, comparing pricing data in the quote with the market pricing data for the financial instrument to identify a crossed market event. Further, the method includes, when the crossed market event is identified, generating a crossed market alert. An additional method covers the case where each price quote is maintained in the resident memory of the quotes analysis module, where an alert may be generated when the previously distributed price quote is crossed within a set time period.

In some embodiments, the method includes applying a set of alert generation rules to assess the crossed market event and generating the crossed market alert is performed only when each of the alert generation rules is determined to be satisfied. In such cases, one or more of the alert generation rules may be defined on an instrument-by-instrument basis, whereby the alert generation rules may differ for differing asset classes. The alert generation rules can include an economic threshold that defines the amount of difference between the pricing data in the quote and the pricing for the financial instrument (as defined by the market data); this threshold or amount must be exceeded before generating the crossed market alert. In some implementations of the method, the threshold can define the amount of difference based on: a current amount; a percentage of the pricing data in the quote; a standard deviation; or other mathematical algorithms/measures.

In some embodiments of the method, the alert generation rules include a direction of the crossed market state. In some cases, the alert generation rules include a time window defining a time period during which the comparison step is performed for the quote to determine the crossed market event. Further, the pricing data in the quote may include a bid price and an ask price for the financial instrument. Then, the comparison step may include determining whether the bid is greater than any ask in the market data or whether the ask is lower than any bid in the market data (e.g., among bids and asks received from other market makers or data from the buy side of the OTC market).

### BRIEF DESCRIPTION OF THE DRAWINGS

FIG. 1 illustrates, in functional block form, a computer system or network of computer and communication devices implementing a crossed market alert generation method for a OTC market makers for bonds, loans, CDSs, and/or other financial instruments or securities;

FIG. 2 is a process flow diagram of an exemplary crossed market alert method based on the present description such as during operation of a market including the system of FIG. 1;

FIG. 3 is a flow diagram of an alert generation method such as may be implemented by the crossed market module of the system of FIG. 1 and as a step within the method of FIG. 2;

FIG. 4 is an example of a screen with a market view provided to a system administrator during a crossed market alert process described herein such as during operation of the system of FIG. 1;

FIG. 5 is an example of a screen with an alert generation monitoring view provided by the quotes analysis module to a system administrator such as during operation of the system of FIG. 1; and

FIG. 6 is an example of a screen during the operation of a market maker's communication device where the market maker views a sample crossed markets alert generated and transmitted by an alert generation system such as during operation of the system of FIG. 1.

### DETAILED DESCRIPTION

The following description describes the use of software (and/or hardware) implementations to provide the technology architecture to enable or provide alerts to market makers when a market maker's quote price (bid or ask) is crossed relative to other quoted prices in a financial market. The financial market is not typically a transparent or exchange-based market where current prices for securities are published, but it is instead a non-transparent market such as an over-the-counter (OTC) market for financial instruments such as, but not limited to, loans, bonds, CDSs, non-standard securities, etc. To this end, a crossed markets monitoring mechanism (e.g., a suite of software programs or a software product) is run as part of an alert generation system.

The monitoring mechanism functions to determine when an observed quote from a market maker is crossed with another market maker based on a number of alert generation and transmittal rules. An alert is not necessarily transmitted each time a crossed market condition is detected, but only when additional rules or conditions are determined to be satisfied by the monitoring mechanism. For example, an alert may be generated only when it is determined to be of economic interest (e.g., the amount of disparity exceeds an economic threshold). Further, to maintain the integrity of the market, the rules may prevent generation of an alert in particular circumstances, e.g., by limiting the number of alerts for an instrument type for a particular time period to minimize risks of a market maker gaming the alert system. Additionally, the alert generation rules may be default rules established for a particular market or the rules may be adjusted or set by the market maker or by a system administrator to implement preferences of a particular market maker (note that market maker preferences are controlled by, and may be overridden by, the system alert generation rules, again, to prevent gaming of the system).

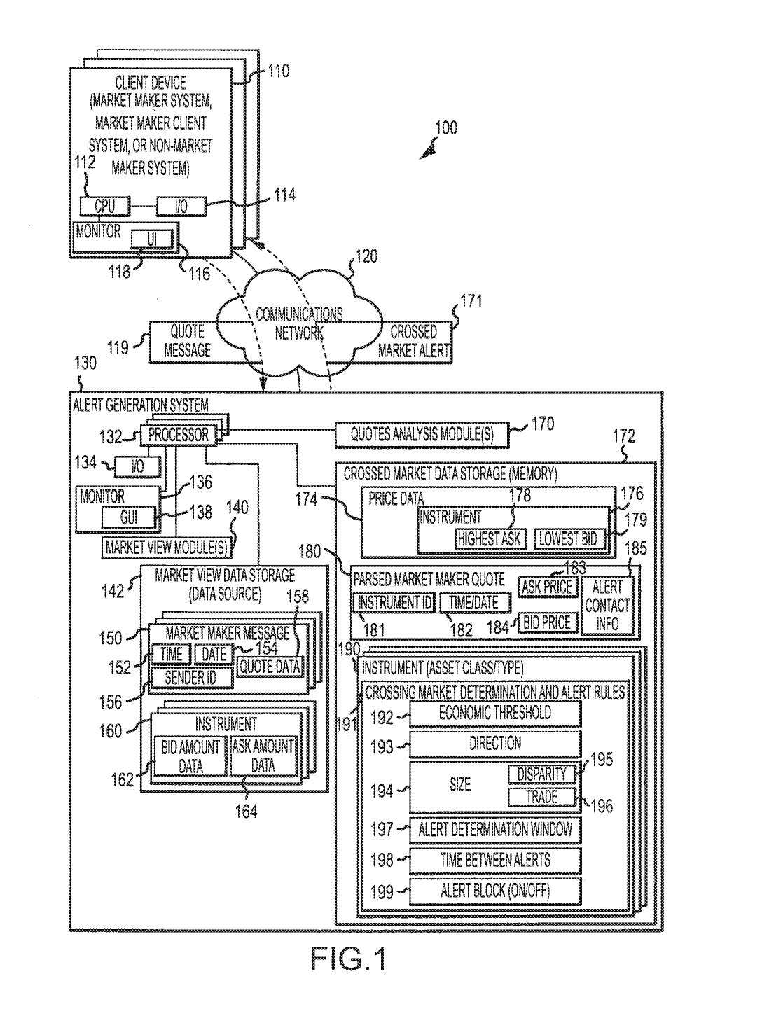

FIG. 1 illustrates a system 100 for use in determining when crossed market conditions exist for a market maker and when it is appropriate to generate and transmit a crossed market alert communication to the market maker (or a designated recipient). The crossed market alerts (shown at 171 in FIG. 1) can be provided as a standalone service to market makers (or liquidity providers) or as part of a more comprehensive service or suite of services, e.g., alerts provided in addition to other communications with market data for an OTC market.

As shown, the system 100 includes a number of client devices or market maker systems 110 that are operated by market maker personnel to submit quote messages 119 and to also receive crossed market alerts 171 (or two differing devices can be used for sending and receiving messages 119, 171). In some embodiments, the system 100 also includes client devices similar to devices 110 that provide messages to the alert generation system 130 from non-market makers, and these messages may include price quotes that may be extracted by the alert generation system 130 to create the price data 174 stored in memory 172. The client devices 110 typically include a processor or central processing unit (CPU) 112 that operates to manage or run input and output (I/O) devices 114, e.g., keyboard, touchscreen, mouse, etc., used to allow an operator to enter information including financial instrument identification information and bid and ask prices for the identified instrument. This information is transmitted in a quote message 119 to alert generation system 130 via communications network 120 (e.g., an intranet, the Internet, or other digital communications network) in a wired or wireless manner, and the quote message 119 may take the form of an e-mail message in some embodiments of system 100. The CPU 112 also runs a monitor 116 on client device 110 to provide a user interface 118 (e.g., browser, e-mail message program, etc.) that may display the message 119 being generated and also any received market alert message 171. The form of the client device 110 is not limiting of the invention and may include a desktop computer, a laptop, notebook, or other stationary or mobile computing device, or a wireless communication device (e.g., cellular or wireless phone, tablet, computer pad, etc.), or a combination thereof.

The system 100 further includes an alert generation system (or market monitoring system) 130 communicatively linked to the client devices 110 via communications network 120. Note, as shown, no resident software is required on the market maker side or on the client device 110 to generate the crossed market alert 171. The alert generation system 130 may take the form of one or more servers (or other computer devices) and data storage devices provided at one geographic location or with the described functions distributed servers/computers/memory at two, three, or more geographic locations each linked together via network 120 or other communication links. The alert generation system 130 includes one or more processors 132 managing hardware and software components to perform the crossed market alert functions and other functions described herein. For example, the processor(s) 132 runs I/O devices 134 that allow administrators to enter information such as to select or modify crossed market determination and alert rules 191 (as discussed below).

To this end, the system 130 may also include one or more monitors 136 providing a GUI 138 or other screens displaying market data including information relevant to alert determination and generation (e.g., graphs showing pricing data for an instrument, a market maker's quoted prices relative to the market view, and existing alert generation rules (or parameter settings) 191), which may then be modified by the administrator. The alert generation system 130 may be provided through the use of one, two, three, or more systems with portions provided at a single or multiple distributed locations (e.g., the market view modules 140 may be provided on one or more servers that may communicate with the quotes analysis modules 170 provided on differing servers via a wired or wireless communication network).

The processor(s) 132 of the system 130 runs software in the form of a market view module(s) 140 and data storage 142 for the market view module 140. The module 140 creates a view of a financial market such as an OTC market for bonds, loans, or other instruments. To this end, the module 140 receives numerous quote messages 119 from client devices 110 (e.g., a seller side or buyer side market maker) that are stored in memory 142. Each message 150 may include a time 152 and date 154 for the message 150, a sender or market maker 1D 156, and quote data 158 for one or more instruments. The market view module 140 acts to parse, cleanse, and enrich each of these messages 150 to determine the quoted instrument, and, for each instrument 160, to determine a set of bid amount data 162 and a set of ask amount data 164. For example, the module 140 may act to determine all the bid prices 162 and ask prices 164 for each instrument such that this data can be provided to the quotes analysis module 170 as price data 174. Again, note that the market view module 140 and data storage 142 is shown within the system 130, but, in practice, it will be provided often in a system separate from the quotes analysis module 170 and data storage 172. In brief, all quote data is collected and processed by the market view module 140 and the results are monitored by the alert generation system 130 via the quotes analysis module 170.

The processor(s) 132 of the alert generation system 130 further runs (or executes) software or code (in computer-readable media or memory) to provide a quotes analysis module 170. The quotes analysis module 170 functions to determine when a quote in a quote message 119 from a market maker 110 is crossed and whether an alert should be generated and transmitted (as shown at 171 as a crossed market alert). To this end, the processor 132 is shown to manage memory or data storage 172 for the quotes analysis module 170 to store the data it uses as input, the rules and parameters it uses to process the input, and the output of the module 170 (at least temporarily).

During operation of the system 130, the quotes analysis module 170 receives as input the price data 174 from the market view module 140 or another data source (not shown). For each instrument 176, this price data minimally includes a collection of asks and bids from each of the market makers 110 in messages 119. Further, to facilitate determination of a crossed market condition, the module 170 functions to determine for each instrument 176 the highest ask price 178 and the lowest bid 179. In this way, crossed markets can be determined by determining whether a quote 119 from a market maker includes either a bid that is greater than the highest ask 178 for an instrument or an ask that is lower than the lowest bid price for an instrument. This data 174 is updated on a real-time, 24-hours-a-day, 7-days-a-week basis to provide a current market view for a particular instrument or asset class (or instrument or security type).

When a quote message 119 is received by alert generation system 130, the market view module 140 parses, cleanses, and enriches the data and provides a parsed market maker quote 180 to the quotes analysis module 170 as additional input. The enrichment step matches the aliases for the instruments to the underlying instrument, security, or asset to its reference data (e.g., the ticker, coupon, ISIN, and maturity information used to uniquely identify the quoted product). The data cleansing involves statistical analysis to match prices against the market to confirm the prices: (1) are reasonable and in line with how the instrument/security is typically quoted (e.g., compared to market conventions); and (2) fall within average historical ranges.

The parsed quote 180 may include an instrument or asset ID 181 to identify which OTC market or portion of an OTC market the quote is related to (e.g., entity names, tickers, ISINs, RED codes, LXIDs, etc.) and also includes a time/date 182 for the quote 180. Further, the parsed quote 180 may include contact information 185 such as an e-mail address 185 that can be used by the module 170 to identify the source market maker and sender(s) to set recipient(s) for and delivery of an alert 171 over the network 120. The quote 180 also includes an ask price 183 and a bid price 184 for the instrument. This pricing data 183, 184 is compared with the price data 174 (e.g., the ask 178 and bid 179) to determine when the quote 180 is a crossed market quote for which it may be appropriate to generate and transmit a crossed market alert 171 for the market maker 110.

Once a quote is determined to be crossed, the quotes analysis module 170 uses a set of algorithms and/or rules 191 with default or user-selected/modified parameters to determine whether an alert 171 should be generated and sent as shown at 171. Significantly, these rules 191 may be set and differ for each instrument (asset class or asset type) as shown at 190 in memory 172. Briefly, the rules 191 may include an economic threshold 192 such as a currency amount differential (e.g., $1 to several to a greater number of U.S. dollars or Euros) or a percentage difference between a bid or ask price and the market prices and the value of the instrument. In some cases, a direction 193 is determined for the crossed market quote (such as higher or lower), and this direction 193 is used to decide whether or not an alert should be generated. For use in determining when to generate an alert, the rules 191 may also set a size 194 such as a size of disparity 194 (e.g., size of delta or difference from the economic threshold) or a size of trade (e.g., quote may be to buy “X” instruments and the value of X (i.e., the trade size) may indicate whether or not an alert should be generated). The client or market maker may provide or set these parameters such as size parameters or economic thresholds (however, note that system rules control and can override and/or influence alert generation based on parameters set by market makers).

Further, the rules 191 may include an alert determination time-sensitive window 197 that defines for an instrument 190 what time period will be analyzed for crossed markets. For example, a window of minutes to several hours to a day may be set for a highly volatile market while a longer window of a day to several days may be set for a less volatile market in which fewer quotes are submitted and prices change less frequently. The rules 191 may also include safeguards to minimize the risk of a market maker gaming the system 130 to determine actual prices. This may include a time 198 between alerts that defines how often a market maker 110 will receive alerts 171 to limit the number received for a time period (e.g., prevent a maker 110 from submitting numerous quotes 119 in an attempt to determine others' bids/asks). Similarly, each instrument may include an alert block 199 that may be turned on and off such that alerts 171 may be periodically turned off to facilitate needs of a particular OTC market. The alerts 171 may be provided by the module 170 through the use of a web interface, desktop application, etc. and the alerts 171 may take the form of e-mail messages, pop-ups in a web interface 118 of client 110, or messages such as text or voice messages to device 110.

With the system 100 understood, it will be appreciated that the alerts 171 allow a market maker using a client device 110 to mitigate the risk that trades will occur based on submission of crossed market quotes. The quotes analysis module 170 provides data analysis and alerts in real time to address intraday (or intra-trading period) fluctuations in prices of an OTC or similar financial instrument and to reduce risk. The module 170 may be provided as an add-on product or service to quotes or other market monitoring data services provided by the market view module 140 of system 130.

The client devices 110 (operated by either market makers or other market participants) forward e-mails or other electronically formatted price information 119 that contain pricing data to a private e-mail address (or otherwise to system 130). The parsing engine provided by or in module 140 extracts, enriches, and cleans pricing data from the messages 150 (and attachments to messages 119 when included) and then distributes the enhanced pricing data to the client device 110 and also to the quotes analysis module 170 as price data 174 and market maker quotes 180. With the pricing data 160, 174 in system memory, the module 170 can be used to run real-time analysis to determine where crossed markets are occurring. Additionally, real-time alerting 171 is then provided, when appropriate based on rules 191, by the quotes analysis module 170.

Use of the quotes analysis module 170 provides a number of useful advantages over prior attempts to address the crossed markets problem. First, with regard to relevance, the module 170 may use mathematic algorithms defined in part by rules 191 to assess the size, economic impact, and direction of the crossed market to determine the relevance of a quote determined to be crossed such that only client-relevant (or economically interesting) alerts 171 are generated. Second, with regard to anonymity, the alerts are generated so as to maintain the anonymity of market participants and their prices, which prevents the unscrupulous use of the service by market participants in market making activities (e.g., price fixing, collusion, and similar activities).

Third, with regard to alert timeliness, the module 140 typically has minimal delays (e.g., less than 10 seconds) from the time an e-mail message 119 with pricing data is received to the time that pricing data has been parsed, cleaned, enriched, and distributed to the client device 110. Hence, the addition of the quotes analysis module 170 to system 130 with minimal processing delays makes the system 130 a faster and timelier approach to identifying possible crossed market conditions when compared with manual, spreadsheet, and/or phone-based data analysis presently being performed by market makers. Fourth, with regard to market coverage, the number of devices/clients 110 providing inputs 119 may be quite large. In one implementation, over 200 buy-side and sell-side clients in an OTC market may be served and a wide view of market prices (shown at 160 and 174 in FIG. 1) is provided for analysis. In practice, on any given day indicative quotes may be observed from 100 to 150 market makers (or their clients or non-market makers) using devices 110, and the system 130 may analyze 750,000 or more email messages or other electronic communications, which in turn equates to 7,000,000 or more price quotes in OTC markets (to provide price data 174 and parsed market maker quotes 180 to the quotes analysis module 170).

Fifth, multiple asset class coverage may be provided by the system 100, with the instruments 160, 190 including bonds, loans (e.g., syndication loans), credit default swaps (CDSs), variance swaps, credit options, volatility swaps, index rolls, trenches, asset backed securities, and other similar instruments. Providing alerting to the relevant analysts across multiple asset classes likely will bring efficiency to their task of identifying crossed markets. The crossed market alert service provided in system 100 may be provided with the market makers' existing hardware/software systems. For example, client set up at device 110 may be as simple as turning on e-mail message forwarding to a private e-mail address from the alert generation system 130.

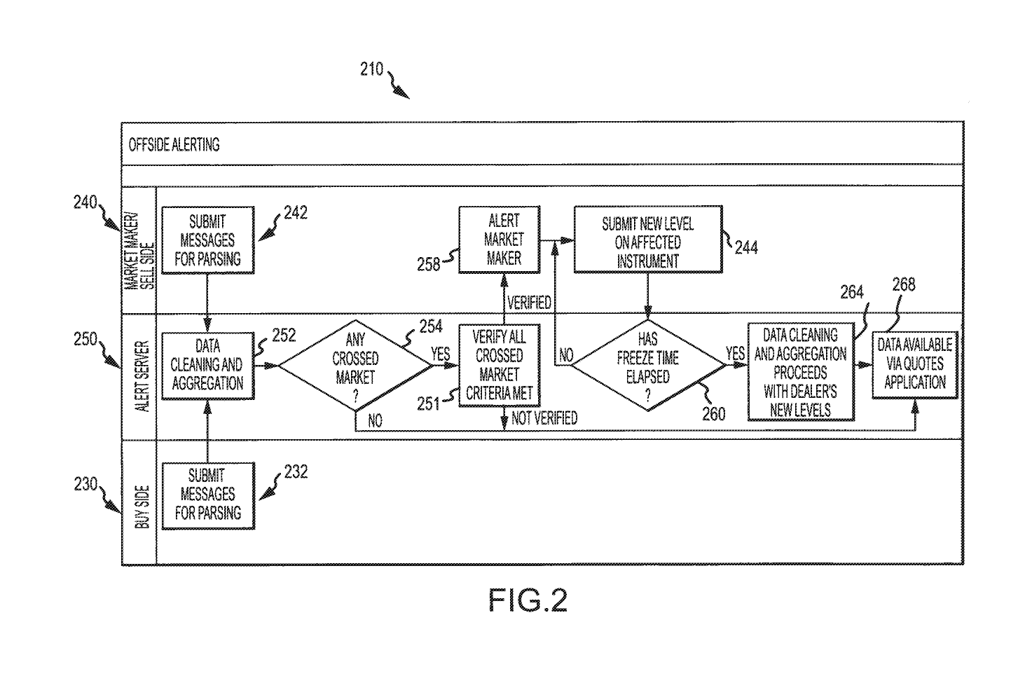

FIG. 2 illustrates a process or method 210 for providing an alerting service such as by operation of the system 100. The steps of method 210 involve communications between buy-side client devices as shown at 230 and an alert server 250 (e.g., alert generation system 130 of FIG. 1, which may be separated into a market view module platform and a quote analysis module platform) and between the server 250 and market maker or sell side devices shown at 240. Specifically, the method 210 includes at 232 and 242, respectively, the alert server 250 receiving messages from the buy-side devices 230 and the sell-side devices 240, and these messages include pricing data for one or more instruments being traded in an OTC or similar non-exchange based market. At 252, the alert server 250 acts to perform data cleaning, enrichment, and aggregation of the pricing data (e.g., to aggregate all bids and asks for each of a plurality of instruments).

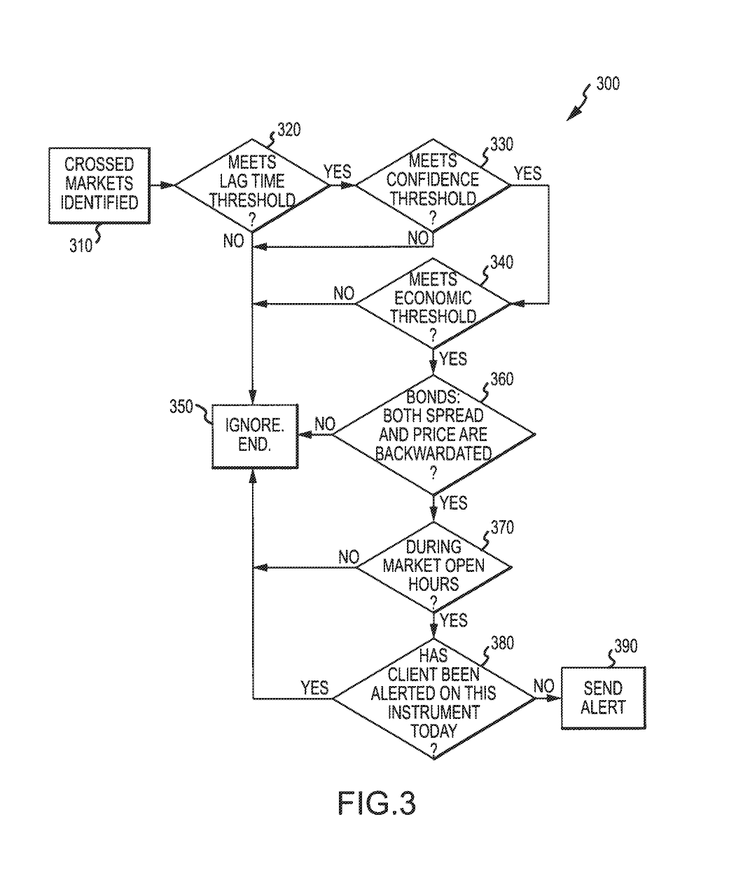

The method 210 continues at 254 with the alert server (e.g., with a quotes analysis module) determining whether any quotes in the messages received at 242 are crossed (as discussed above with reference to FIG. 1 and below with regard to FIG. 3). If not, the parsed/cleansed/enriched data is made available at 268 to the source (e.g., either buy side or market maker) that transmitted the quote message for parsing.

If a crossed markets circumstance is identified in step 254, the method 210 continues at 256 with verifying that all the crossed market criteria have been met. For example, it may involve determining that the crossed market event is economically relevant to the market maker. If not, no alert is generated even though the quote is crossed with the market, and the method continues at 268. If yes, an alert is generated and communicated, as shown at step 258, to the market maker device 240.

At 244, the market maker 240 may revise its quote for the instrument and transmit a new quote communication, which may be received by the alert server 250. At 260, the alert server 250 acts to determine whether a freeze time, or time since last alert, for the instrument has occurred for this market maker. For example, the alert rules may limit each market maker to a particular number of alerts for a time period or may require a prescribed amount of time to elapse before issuing a new alert. If the freeze time has not elapsed, the method 210 may continue with the alert server communicating that an additional amount of time must pass before submission of a revised quote, which may then occur at 244. If the freeze time has elapsed at 260, the method 210 continues at 264 with the cleaning and aggregation by the alert server 250 to reflect the new pricing levels for the instrument for the market maker. Then, at 268, this market data is made available to the market maker or sell side 240 via the alert server 250.

FIGS. 1 and 2 illustrate that the system 130 and method 210 provide data analysis and alerts in real time to address intraday (or inter-trading period) pricing demands and reduce exposure to OTC market inefficiencies and mispriced security risks. The crossed market alert methods described herein may include providing visual alerts to subscribed clients (e.g., liquidity providers for an OTC market), providing e-mail alerts, and/or end of day summary reports. The alert may include useful crossed markets data such as an instrument ID, the bid and ask price submitted, the direction of backwardation, etc., but the alert would not provide the market price level(s) for the instrument to maintain the integrity of the OTC market.

In practice, the size of crossed market is compared typically with an economic threshold to assure that the disparity of the crossed market (or difference between bid/ask or ask/bid) is economically interesting. If it is not economically interesting, no alert is generated for this market maker based on the crossed price. The determination of what is economically significant is determined based on rules and/or parameters set for each asset class or instrument and the market segment of the instrument. For example, differing sets of default rules and parameters may be stored in memory for high yield bonds, investment grade bonds, CDSs, loans, etc. Then, the quotes analysis module may first determine which rules/parameters apply to the particular instrument and whether the rules/parameters are default rules or have been (or need to be) configured to suit a market maker's/client's input settings. A market maker may provide input on what is economically interesting to them for each asset class (or types of instruments) that they trade and for which they are receiving the crossed market alert service. When the disparity of the crossed market or crossed price is determined to surpass the economic threshold, an alert may be generated for the market maker (or additional rules may be applied that may prevent the issuance of the alert).

The quotes analysis module may also determine the direction of the backwardation, and, when generated, the alert may indicate for the crossed market the direction of the crossed quote. For example, a direction may indicate that a bid was too high or an ask was too low. During the alert method, the data is aggregated anonymously such that the market makers receiving their cleansed pricing data and alerts cannot identify other pricing data sources (e.g., other market makers). Time-sensitive windows are used and may be set for each asset class (or instrument type) based on liquidity (e.g., larger time window if low volatility or smaller time window if high volatility). A crossed market state may be determined by limiting the pricing comparison to pricing data for this time period, e.g., by comparing a bid and an ask to all asks and bids for the last 20 to 60 minutes in a volatile market or for the last four hours to several days for a low volatility market. As described, protection is provided by the alert generation method to prevent market makers from intentionally submitting multiple crossed levels to generate consecutive alerts that would signal the disparity of the crossed market and present market price on a given instrument.

FIG. 3 illustrates a flow diagram of an alert generation method 300 such as may be performed by the quotes analysis module 170 of FIG. 1 and as steps 254, 256, and 258 of the process 210 of FIG. 2. As shown, the method 300 begins with determining at 310 that a quote communication (e.g., an e-mail message) from a market maker includes at least one quoted price (e.g., a bid or an ask) for an instrument that is crossed with quoted prices from other market participants, which typically are captured by the system from both buy and sell side market participants. At 320, the method 300 continues with determining whether a lag time threshold has elapsed since a prior alert was issued to this market maker for this instrument (or instrument class). For example, the lag time for an asset class may be set to suit the volatility of a particular market.

If the lag time threshold has not elapsed, the crossed market identified at 310 may be ignored, and the method 300 ended until a next quote message is received from the same or another market maker. If the lag time threshold has lapsed at 320, the method 300 continues at 330 with determining of a quote quality confidence threshold is satisfied. For example, the quotes analysis module may perform a test of the quote or pricing data to determine if it satisfies data quality rules. For example, the market view module 140 may use a confidence scoring methodology that considers asset class, trading conventions, timeliness, size of disparity between quotes, and prices of related instruments/securities to indicate whether or not the same price quote appears to be correct.

If the confidence threshold is not met, the method 300 ends at 350. If it is met, the method continues at 340 with determining if the disparity of the crossed market satisfies or exceeds an economic threshold. Again, this threshold may be expressed in differing values, e.g., a percentage (e.g., 5, 10, 15, or some other percentage of the value of the instrument), a currency value (e.g., a number of dollars, Euros, etc. regardless of the instrument value), etc. The economic threshold may be devised by a series of algorithms that are dynamically set based on market factors such as asset class, instrument liquidity, historical price ranges, number of quoting market makers, etc. If the economic threshold is not met at 340, the method 300 ends at 350. If it is met, the method 300 continues at 360 with determining, when the instrument is a bond, whether both the spread and the bid or ask price are crossed (not just the price). If not, the method 300 ends at 350, but, if yes (or the instrument is not a bond), the method 300 continues at 370 and may make a determination of whether the market is open (“is the quote received during market hours?”). If the market is not open, the received quote may be ignored at 350 (or stored until the next trading session and the method 300 continued at 370 the next session).

If the market is open at 370, the method 300 continues at 380 with a determination of whether or not the client or market maker has been alerted on this instrument during a particular time period. Note, the method 300 may be configured to run during active market hours across the globe, e.g., even though a London (or some other city) market may be closed, the method 300 may run to overlap with a New York City (or some other city) market. For example, it may be desirable to limit a market maker to only receiving one alert on a particular instrument per business day to prevent the market maker from gaming or playing the alert method to determine market prices. If the number of alerts is met for the time period, the quote's crossed market is ignored and the method 300 ends at 350. If not, the method 300 continues at 390 with generation and transmittal of the alert at 390 to the market maker, e.g., to their computer, computer system, wireless communication device, or similar system/device.

Further details of selected unique features and functionality of the alerting system (or the method implemented by such a system) are provided as follows. In some embodiments, a dealer or market maker is notified of a price dislocation (or crossed price) by e-mail message or other communication with the details of the event in real time. By “real time,” it is meant that typically an alert is transmitted within seconds of the crossed market discovery. The alert contact list (e.g., e-mail addresses) may be configurable by the market maker such as via a user interface provided on their client device or node, a direct data feed or standard messaging API (e.g., an IBM message queue, a Microsoft message queue, a Java message queue, etc.). The alert may act to notify the market maker of the price dislocation by a visual alert such as with a visual pop-up notification in a market monitoring interface when they are logged into the alert/market monitoring service.

In some embodiments, the time threshold for a crossed market may be set such as by a system administrator of the alert service. This setting may be configurable thresholds of a number of minutes during which the crossed market occurred and can be set per asset class to fit the expected volatility of each class, e.g., different time threshold for loans, bonds, CDSs, and other supported asset classes. In practice, the quotes analysis module uses a window of some number of minutes for determining a crossed market by looking at only instrument prices or bids and asks received within this time frame to provide valid demonstrations of market movements with which the market maker is not keeping pace and stands at risk. Preferably, these time thresholds or windows are configurable so that they can easily be updated, e.g., if a given asset class becomes more or less liquid. For example, the system may hold a predefined number of quotes in memory for comparison up to a predefined number of minutes (the time threshold). After this number of minutes has elapsed, the oldest quotes are dropped from the comparison list.

The market hours used for crossed market analysis may also be set. This setting provides the ability to configure the alert generation system for market-open hours during which crossed market alerts should be run (i.e., ignore after-market close level runs). This configuration option is useful because in some embodiments only quotes received during user working hours are considered for crossed market tests (e.g., from when a first market, e.g. a Tokyo market, opens until a second market, e.g., a New York City market, closes). Quotes received during after-hours are ignored for the crossed market tests, with the definition of “after-hours” or market hours being configurable or being defined by a system administrator (or the market maker in some cases).

Typically, the alert generation system is also adapted to allow the crossed market economic threshold to be reset from a default setting for an instrument by the system administrator or a market maker (subscriber to the service). For example, an ability may be provided to configure the system to set thresholds for an amount of overlap in crossed markets; thresholds for each asset class; and, in some cases, thresholds for each market segment within an asset class. In this way, the amount of difference found in the crossed market may be used to determine whether the crossed market is “economically interesting” as may be defined or set by the market maker (e.g., may differ among the various market makers for a particular asset class or instrument type).

The phrase “economically interesting” may be defined as an event, price, trade, etc. having a material effect on a particular financial market for a given entity or market maker. Hence, the economic threshold may vary by asset class and market segment, e.g., a different threshold may be set for high yield bonds (i.e., more volatile so relatively high threshold) versus investment grade bonds (i.e., less volatile so lower threshold than high yield bonds). The amount of variance used for the threshold may be defined as a percent difference and/or a standard deviation or other mathematical measure. For example, a reasonable price threshold may be set for exclusion from use in a crossed market test (e.g., no alert generated when variance is less than this economic threshold), and, in the case of a standard deviation-based threshold, a quote that is five standard deviations off the market may be identified as a mis-parse or a quote submitted in error by a market maker based on probabilities. Such exclusion thresholds may also be configurable by the system administrator to tune the operation of the quotes analysis module.

During operation of the alert generation system, data is kept anonymous such that market makers or liquidity providers that subscribe to the alert service (e.g., receive alerts) are not able to identify other market participants. Any market participant data displayed to an alert recipient will be kept anonymous, and typically, only the subscribing client's levels are attributed back to the user with the original quote/sender.

It is important that market makers cannot work the system to get multiple alerts on the same instrument within a predefined time period, which may vary by instrument. The alert generation system prevents this undesirable market activity by setting multiple alert triggering rules. For example, the system may operate such that only one alert can be raised per market maker (quote source) per instrument per day or asset class-specific time period (e.g., per day, per hour, etc.) to minimize the risk of revealing market levels. The multiple alert trigger or time window is configurable preferably by a system administrator, which may allow alert generation rule adjustments to suit changes in liquidity or volatility in markets.

The system typically is configurable to set a confidence level in the received, quotes or pricing data accepted from the market view data source as input to the quotes analysis module for use in crossed market alert generation. For example, the confidence threshold may be set at a particular level such as “10” so that quotes are considered only for crossed market analysis when they have a minimum confidence of 10. As with other thresholds, the confidence threshold for input pricing data should be configurable by the system administrator to assure data quality.

When an alert is generated, the quotes analysis module functions to include a set of relevant details to provide information useful for adjusting pricing levels to a market maker. For example, a crossed market alert may include: (a) instrument ID (e.g., ticker, CUSIP/ISIN/RED/etc., and/or an instrument description); (b) client level, which may indicate the market maker's prices parsed from their transmitted quote message; (c) depth, which indicates the number of quotes considered when checking or testing for off-market prices; (d) lag, which may show the time span between the first quote considered in the testing and the latest arrived quote on the particular instrument; (e) standard deviation of the mid of the market maker's quote from the market; and (f) original message to allow the market maker to verify that it did not make a data entry error and that the alert generation system did not mis-parse the data.

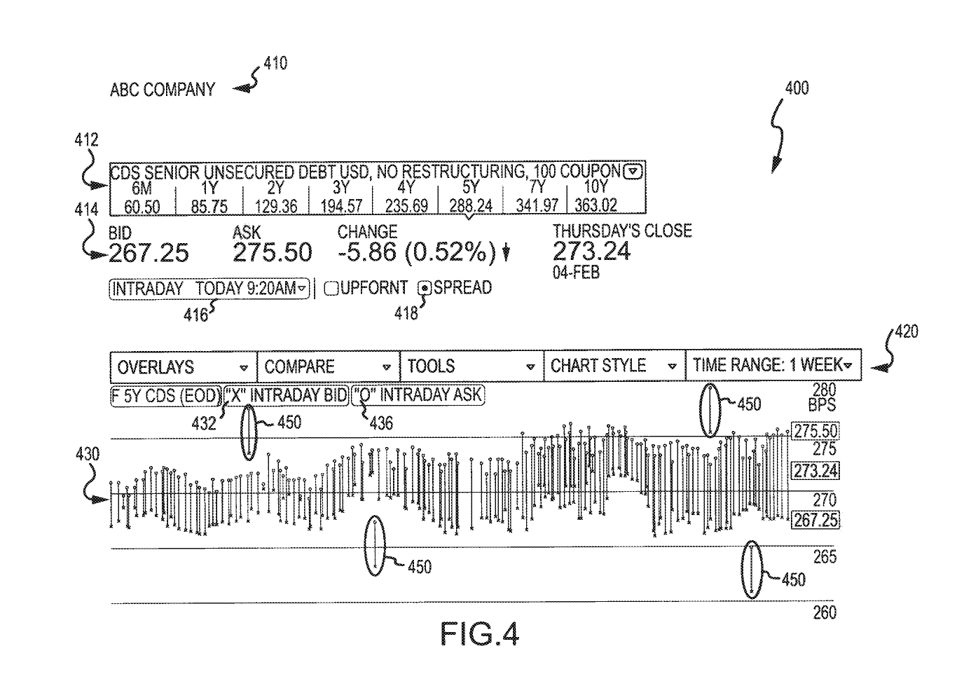

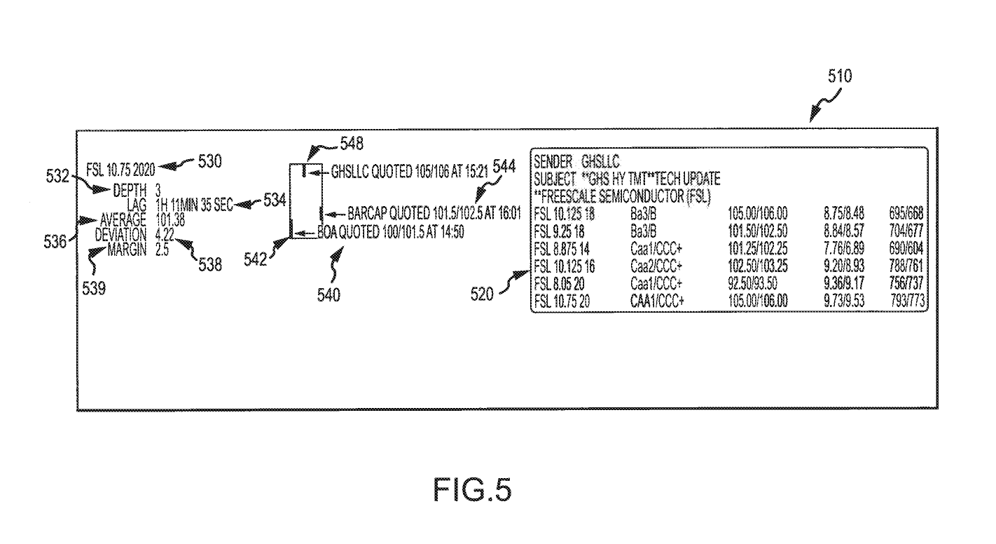

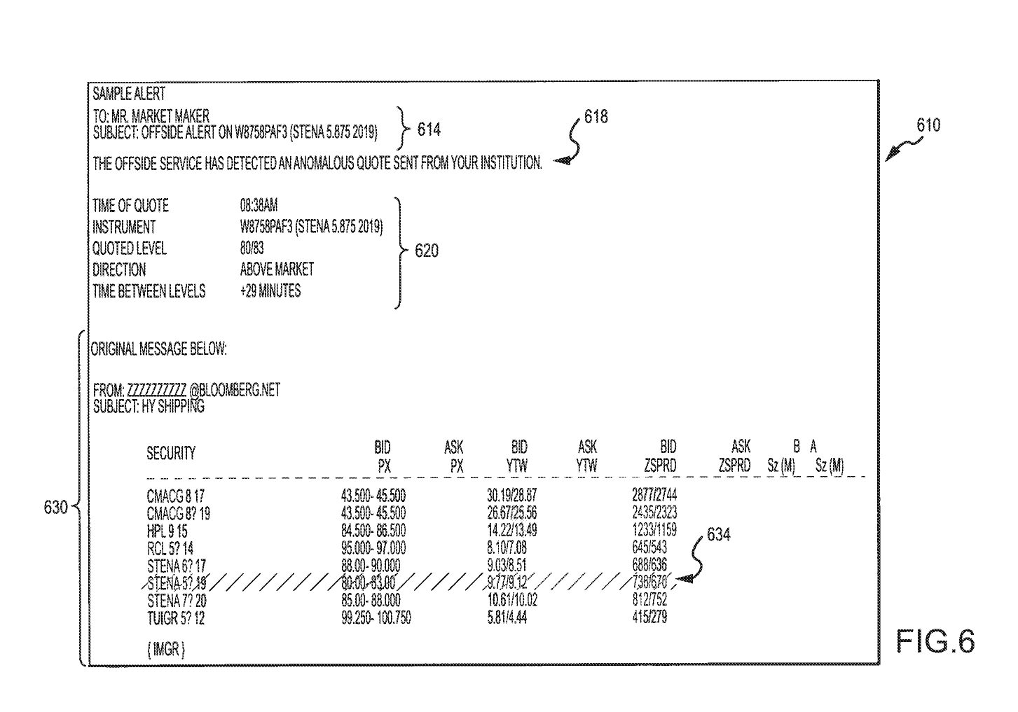

With the above discussion and FIGS. 1-3 in mind, it may now be useful to provide more concrete or “real world” examples including a screen example (FIG. 4) of a monitored OTC market viewable by a system administrator, a screen example (FIG. 5) of an analyzed message from a market maker that is triggering alert generation that is again displayed on a system administrator GUI or monitor, and a screen example (FIG. 6) of a representative crossed market alert that may be displayed on a market maker or client device in response to transmittal of a crossed market alert by the systems described herein (e.g., each of the screen examples may be created by operation of system 100 and/or performing methods 210 and 300).

The alert service described herein notifies liquidity providers or market makers when their quote prices are dramatically out of synchronization with the rest of the market. Off-market quotes result in generation of alerts that provide timely feedback to these liquidity providers. The alert service helps mitigate risks associated with excessive price volatility in select OTC markets, which, in turn, may help address capital and liquidity risk issues in these OTC markets. The alert thresholds combine time, asset class-specific attributes, and statistical analysis to provide effective and relevant crossed market alerts. In some embodiments, the alert services are based on price data or observed market data and message flow from many (e.g., 150 to 200 or more) market participants (buy and/or sell-side).

FIG. 4 shows a screen example 400 of a market view provided to a system administrator during a crossed markets alert process (as described herein) such as during operation of the system 100 of FIG. 1. The screen example 400 provides a market view for the “ABC Company” as indicated or identified at 410 with the monitored asset class or instrument a CDS curve as shown at 412. At 414, market data or pricing data for the instrument (a 5y CDS tenor in this case) is provided including the last bid, last ask, determined change, and price. At 416, a drop box is shown that indicates the type of view provided and the time the view was generated. Further, at 418, the administrator has selected or chosen to view a spread graph, and, at 420, the time range for the market view is chosen (here, a time range of 1 week has been selected but other time periods from minutes to hours to days may be chosen).

At 430, a graph is provided showing quotes in spread fashion that have been received for the chosen CDS for the company identified at 410 for the past week. As shown at 432 and 436, the spreads are defined by intraday bids and asks for the CDS (or other financial instrument being monitored in such a market view screen example 400). Significant to the present discussion of alert generation, a number of off-market quotes are indicated at 450 that would be identified by a quotes analysis module as a crossed market from the observed quotes from market makers. The upper two quotes include bids that are higher than the highest ask and the lower two quotes include asks that are lower than the lowest bids. If these crossed markets are determined to be economically interesting (as discussed above) and other alert generation rules are met, a crossed market alert is transmitted to the subscribing market makers published the quotes for this instrument (a 5y CDS tenor for the ABC company).

FIG. 5 shows a screen example 510 of an alert generation monitoring interface that may be provided to a system administrator of an alert generation system (e.g., the system 130 of FIG. 1). For example, the administrator may inspect an alert generation event identified by the quotes analysis module that may result in an alert generation to a market maker. During operation of an alert generation system, a message 520 is the original message with the quotes from a market maker as identified near the top of the message shown, and the message 520 includes quotes for one or more financial instruments monitored by the alert generation system.

Parsing or cleaning the message 520 by the alert generation system provided a set of data including an identification of the instrument as shown at 530. The pricing data for this instrument is shown in market view 540 at 548 (e.g., a bid of 105 and an ask of 106). As shown in the internal administrator view at 532, the market view 540 (or crossed market testing) has a depth of three quotes with prices from the other two sources shown at 542 and 544. The lag or time window for crossed market testing is shown at 534 with, in this case, about one hour present between the first and last quotes 542, 544. The average of the prices is shown at 536, e.g., 101.38 in this example. Further, the standard deviation is indicated as being 4.22 at 538 and a margin is calculated by the alert generation system as being 2.5 as shown at 539.

As shown in the market view 540, the message 520 has been flagged by the quotes analysis module as generating a crossed market alert to be sent to the service subscribing originator of the message 520. Specifically, the quote for instrument 530 is shown at 548 to include a bid that is higher than any ask made by the other market makers as found in quotes 542, 544. Hence, the quote 548 is determined to be crossed with quotes 542, 544, and an alert is generated if the variance is determined to be economically interesting and other alert generation rules are met.

FIG. 6 shows a screen example 610 during operation of a market maker's communication device to view a sample crossed market alert generated and transmitted by an alert generation system such as during operation of the system 100 of FIG. 1. As discussed above, the alert in screen example 610 may be generated by a quotes analysis module when a market maker communicates a message with a quote that is crossed with the quotes of other observed market prices. As shown in screen example 610, a header 614 may indicate the recipient of the alert and provide an indication that the contents are related to an economically interesting crossed market event for a recently provided quote on a particular instrument.

The body 620 of the alert in screen example 610 may include information that is useful to the recipient or market maker in deciding if the quote should be revised to better follow or match market activity for the instrument. As shown, the body 620 includes the time the quote was submitted, the instrument for which the quote (ask/bid prices) was provided, the quoted level (bid/ask obtained by cleaning the data in the original quote-containing message), the direction of the crossed market (here the bid is indicated as being higher than any ask by more than an economic threshold), and the time between levels. Further, the alert may include additional information such as the original quote-containing message 630. This additional information may include highlighting the quote 634 that caused or triggered the alert, which allows the recipient to determine if there was an error on their part or a mis-parsing by the alert generation system.

Embodiments of the subject matter described in this specification can be implemented as one or more computer program products, i.e., one or more modules of computer program instructions encoded on a computer-readable medium for execution by, or to control the operation of, data processing apparatus. For example, the modules/software used to provide the architecture/system 100 such as the modules 138 and 170 and similar modules/software may be provided in such computer-readable medium and executed by processor(s) 132. The computer-readable medium can be a machine-readable storage device, a machine-readable storage substrate, a memory device, a composition of matter affecting a machine-readable propagated signal, or a combination of one or more of these types of media. The terms “client device” and “alert generation system” encompass all apparatus, devices, and machines for processing data including, e.g., a programmable processor, a computer, or multiple processors or computers. The system (such as devices and servers in system 100 of FIG. 1) can include, in addition to hardware, code that creates an execution environment for the computer program, e.g., code that constitutes processor firmware, a protocol stack, a database management system, an operating system, or a combination of one or more of these items.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry. Processors suitable for the execution of a computer program include, e.g., both general and special purpose microprocessors, and any one or more processors of any kind of digital computer. Generally, a processor receives instructions and data from a read-only memory or a random access memory or both. Generally, the elements of a computer are a processor for performing instructions and one or more memory devices for storing instructions and data. The techniques described herein may be implemented by a computer system configured to provide the functionality described.

For example, FIG. 1 is a block diagram illustrating one embodiment of a computer system configured to implement the methods described herein such as with reference to FIGS. 2-6. In different embodiments, the computer system 100 with its client devices 110 and system 130 may be any of various types of devices including, but not limited to, a personal computer system, desktop computer, laptop computer, notebook computer, netbook computer, mainframe computer system, handheld computer, workstation, network computer, application server, storage device, a consumer electronics device (e.g., camera, camcorder, set top box, mobile device, video game console, handheld video game device, etc.), a peripheral device (e.g., switch, modem, router, etc.), or, in general, any type of computing or electronic device.

Typically, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, a digital camera, etc. Computer-readable media suitable for storing computer program instructions and data include all forms of non-volatile memory, media and memory devices, including, e.g., semiconductor memory devices (e.g., EPROM, EEPROM, and flash memory devices), magnetic disks (e.g., internal hard disks or removable disks), magneto-optical disks, and CD-ROM and DVD-ROM disks. The processor and the memory can be supplemented by, or incorporated in, special purpose logic circuitry.

To provide for interaction with a user (with an I/O portions 114 and 134 of client device 110 and alert generation system 130 or monitors 116 and 136 of device 110 or system 130), embodiments of the subject matter described in this specification can be implemented on a computer having a display device, e.g., LCD (liquid crystal display) or LED (light emitting diode) monitor, for the computer to display information to the user; and a keyboard and a pointing device, e.g., a mouse or a trackball, for the user to provide input to the computer. Other types of devices can be used to provide for interaction with a user as well, e.g., feedback provided to the user can be any form of sensory feedback, e.g., visual feedback, auditory feedback, or tactile feedback; and input from the user can be received in any faun, including acoustic, speech, or tactile input such as may be useful for providing telephony communications with telephony I/O or similar forms.

While this document contains many specific details, these details should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this depiction should not be understood as requiring that such operations be performed in the particular order shown or in sequential order, or that all illustrated operations be performed, to achieve desirable results. In certain circumstances, multitasking and/or parallel processing may be advantageous. Moreover, the separation of various system components in the embodiments described above should not be understood as requiring such separation in all embodiments, and it should be understood that the described program components and systems can generally be integrated together in a single software and/or hardware product or packaged into multiple software and/or hardware products.

1-8. (canceled)

9. A non-transitory computer-readable storage medium with an executable program stored thereon causing a computer to perform the following steps:
accessing pricing data including a plurality of ask and bid quotes for a financial instrument, wherein the pricing data is not published information that is available to participants in a market for the financial instrument;
receiving a quote from one of the market participants, the quote including a bid amount and an ask amount for the financial instrument; and
determining the quote is crossing markets based on the pricing data.

10. The computer readable medium of claim 9, wherein the determining step includes determining one of the bid amount is greater than all of the ask quotes for the financial instrument and the ask amount is lower than all of the bid quotes for the financial market.

11. The computer readable medium of claim 10, further comprising determining a crossing markets amount, determining the crossing markets exceeds an economic threshold, and, when exceeded, transmitting a crossing markets alert governed by system rules.

12. The computer readable medium of claim 11, wherein the economic threshold is defined by user input and is specific to an asset class including the financial instrument.

13. The computer readable medium of claim 11, wherein the economic threshold is a currency amount, a percentage of instrument pricing, or based on a standard deviation.

14. The computer readable medium of claim 11, further wherein the crossing markets alert is only generated after verifying that a set of crossing market criteria are satisfied including that an alert freeze time has elapsed for submitter of the quote for the financial instrument.

15-20. (canceled)

21. The computer readable medium of claim 9, wherein the determining step further comprises applying a set of alert generation rules to assess the crossing markets event, wherein the generating of the crossing markets alert is performed when each of the alert generation rules is determined to be satisfied.

22. The computer readable medium of claim 21, wherein at least one of the alert generation rules is defined on an instrument-by-instrument basis, whereby the alert generation rules may differ for differing asset classes.

23. The computer readable medium of claim 21, wherein the alert generation rules include an economic threshold defining an amount of difference between the pricing data in the quote and the pricing for the financial instrument defined by the market data that must be exceeded before performing the generating of the crossing markets alert.

24. The computer readable medium of claim 23, wherein the amount of difference is a currently amount, is a percentage of the pricing data in the quote, or is based on a standard deviation.

25. The computer readable medium of claim 21, wherein the alert generation rules include a direction of backwardation that, when identified for the crossing markets event, results in performing the generating of the crossing markets alert.

26. The computer readable medium of claim 21, wherein the alert generation rules include a time window defining a time period during which the comparing step is performed for the quote to determine the crossing markets event.

27. The computer readable medium of claim 9, wherein the pricing data includes a bid and an ask for the financial instrument and wherein the comparing of the pricing data includes determining whether the bid is greater than any ask in the market data or whether the ask is lower than any bid in the market data.

28. The computer readable medium of claim 9, wherein the financial instrument is a loan, a bond, an option, a credit default swap, a variance swap, a volatility swap, a swaption, a tranche, an index roll, or other OTC-traded product.

29. A non-transitory computer-readable storage medium with an executable program stored thereon causing a computer to perforin the following steps:
accessing pricing data including a plurality of ask and bid quotes for a financial instrument, wherein the pricing data is not published information that is available to participants in a market for the financial instrument;
receiving a quote from one of the market participants, the quote including a bid amount and an ask amount for the financial instrument; and
determining the quote is crossing markets based on the pricing data,
wherein the determining step includes determining one of the bid amount is greater than all of the ask quotes for the financial instrument and the ask amount is lower than all of the bid quotes for the financial market,
further causing the computer to perform the steps of determining a crossing markets amount, determining the crossing markets exceeds an economic threshold, and, when exceeded, transmitting a crossing markets alert governed by system rules.

30. The computer readable medium of claim 29, wherein the economic threshold is defined by user input and is specific to an asset class including the financial instrument.

31. The computer readable medium of claim 29, wherein the economic threshold is a currency amount, a percentage of instrument pricing, or based on a standard deviation.

32. The computer readable medium of claim 29, further wherein the crossing markets alert is only generated after verifying that a set of crossing market criteria are satisfied including that an alert freeze time has elapsed for submitter of the quote for the financial instrument.

33. The computer readable medium of claim 29, wherein the financial instrument is a loan, a bond, an option, a credit default swap, a variance swap, a volatility swap, a swaption, a tranche, an index roll, or other OTC-traded product.
